(19) United States
(12) Patent Application Publication
(10) Pub. No.: US 2015/0170484 A1
(43) Pub. Date: Jun. 18, 2015

(54) SYSTEMS AND METHODS FOR SENSING AND IDENTIFYING INFORMATION HANDLING RESOURCES IN A DISAGGREGATED SERVER

(71) Applicant: Dell Products L.P., Round Rock, TX (US)

(72) Inventors: Eric Alan Kuzmack, Georgetown, TX (US); Kevin D. Terwilliger, Austin, TX (US); Shawn Joel Dube, Austin, TX (US); Stacy A. Gower, Leander, TX (US); Gianna Taylor, Pflugerville, TX (US); Carl W. Kagy, Austin, TX (US)

(73) Assignee: Dell Products L.P., Round Rock, TX (US)

(21) Appl. No.: 14/109,439

(22) Filed: Dec. 17, 2013

(51) Int. Cl. G08B 5/36

(52) U.S. Cl. CPC G08B 5/36

(57) ABSTRACT

In accordance with embodiments of the present disclosure, a method may include, in a chassis comprising a plurality of slots each configured to receive a module and electrically and communicatively couple the module to other components of the chassis, receiving an electrical signal indicative of a user interaction with an interface button integral to a first module received in one of the plurality of slots. The method may also include, responsive to the signal, causing display, from a respective visual indicator from each of one or more other modules which are a part of the same computing system as the first module, of a visual indication that the module having the visual indicator is part of the same computing system as the first module.

### TECHNICAL FIELD

The present disclosure relates to modular information handling systems. More specifically, embodiments of the disclosure provide systems and methods for removing information handling resources from a chassis configured to house multiple modular information handling resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Existing server architectures either provide a single monolithic server capable of running one operating system (or a single hypervisor running multiple virtualized operating systems) and input/output (“I/O”) resources at a time, or bulky blade server chassis providing multiple servers and I/O control modules in a single chassis. A system chassis with multiple information handling systems with various peripheral and I/O capabilities common to the chassis as a whole may provide advantages, as it allows a blade server chassis in a small form factor, thereby providing a blade server chassis with a size comparable to the size of a monolithic server. Implementation of a system chassis with multiple information handling systems with various peripheral and I/O capabilities common to the chassis as a whole presents numerous challenges.

### SUMMARY

In accordance with the teachings of the present disclosure, the disadvantages and problems associated with traditional approaches to sensing and identifying information handling resources in a modular chassis have been substantially reduced or eliminated.

In accordance with embodiments of the present disclosure, a method may include, in a chassis comprising a plurality of slots each configured to receive a module and electrically and communicatively couple the module to other components of the chassis, receiving an electrical signal indicative of a user interaction with an interface button integral to a first module received in one of the plurality of slots. The method may also include, responsive to the signal, causing display, from a respective visual indicator from each of one or more other modules which are a part of the same computing system as the first module, of a visual indication that the module having the visual indicator is part of the same computing system as the first module.

In accordance with embodiments of the present disclosure, a method may include, in a chassis comprising a plurality of slots each configured to receive a module and electrically and communicatively couple the module to other components of the chassis, causing display, from a visual indicator integral to a module, of a first visual indication for identifying a computing system for which the module is a part. The method may also include causing display from the visual indicator of the module of a second visual indication that the module is assigned keyboard-video-mouse emphasis responsive to the module receiving keyboard-video-mouse emphasis.

In accordance with these and other embodiments of the present disclosure, a method may include, in a chassis comprising a plurality of slots each configured to receive a module and electrically and communicatively couple the module to other components of the chassis, receiving a display device at a connector of the chassis. The method may also include, responsive to receiving the display device, causing display, from a visual indicator associated with an interface button for selecting keyboard-video-mouse emphasis for a selected module received in the chassis, of a visual indication that a user may select the selected module for emphasis via user interaction with the interface button.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a cut-away perspective view of a chassis for receiving modular information handling resources, in accordance with embodiments of the present disclosure;

FIG. 2 illustrates a perspective view of an example chassis drawer for carrying modular information handling resources, the drawer in an open position, in accordance with embodiments of the present disclosure;

FIG. 3 illustrates a perspective view of an example chassis drawer for carrying modular information handling resources, the drawer in a closed position, in accordance with embodiments of the present disclosure;

FIG. 4 illustrates a perspective view of another example chassis drawer for carrying information handling resources, in accordance with embodiments of the present disclosure; and

FIG. 5 illustrates a plan view of the chassis depicted in FIG. 1, in accordance with embodiments of the present disclosure.

### DETAILED DESCRIPTION

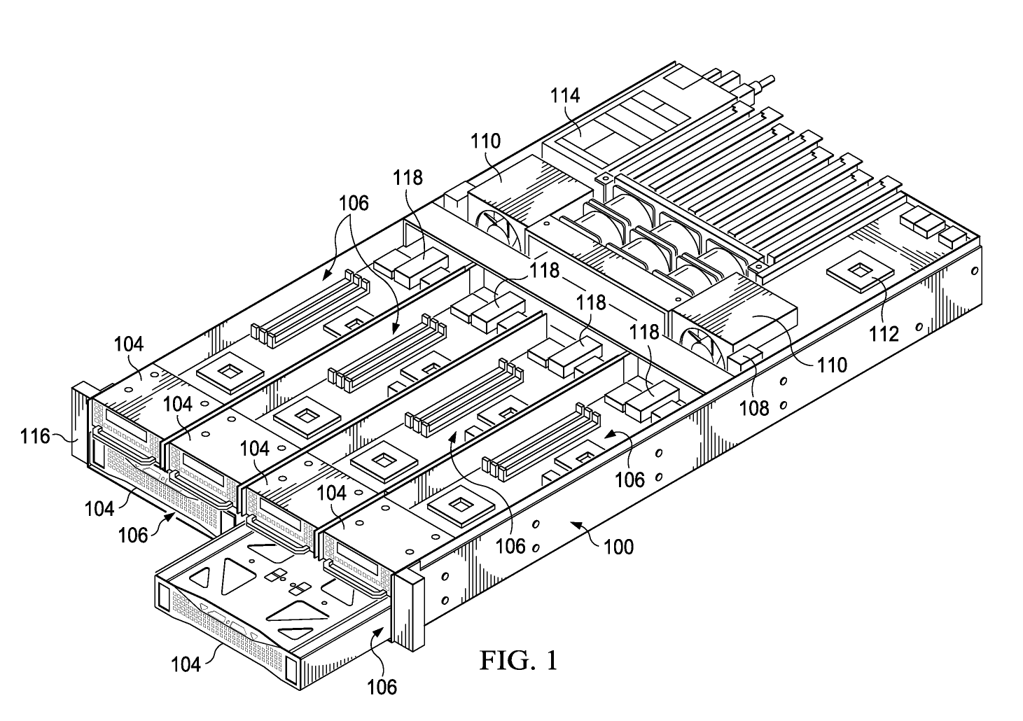

Preferred embodiments and their advantages are best understood by reference to FIGS. 1-5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

In this disclosure, the term “information handling resource” may broadly refer to any component system, device or apparatus of an information handling system, including without limitation processors, busses, memories, input-output devices and/or interfaces, storage resources, network interfaces, motherboards, electro-mechanical devices (e.g., fans), displays, and power supplies.

FIG. 1 illustrates a perspective view of a chassis 100 for receiving modular information handling resources, in accordance with embodiments of the present disclosure, with certain elements (e.g., walls for enclosing components within chassis 100) cut-away or removed in order to show information handling resources internal to chassis 100. Chassis 100 may be an enclosure that serves as a container for various information handling systems and information handling resources, and may be constructed from steel, aluminum, plastic, and/or any other suitable material. Although the term “chassis” is used, chassis 100 may also be referred to as a case, cabinet, tower, box, enclosure, and/or housing. In certain embodiments, chassis 100 may be configured to hold and/or provide power to a plurality of information handling systems and/or information handling resources. As depicted in FIG. 1, chassis 100 may include one or more slots 106 configured to receive drawers 104 for carrying information handling resources, as described in greater detail below. For example, some drawers 104 may include one or more information handling systems. As another example, some drawers 104 may include one or more peripherals (e.g., hard disk drives, graphics processing units, etc.) associated with information handling systems disposed in another drawer 104.

Each drawer 104 may include an interface connector 118 configured to electrically couple to a midplane 108, thus providing electrical coupling between information handling resources carried on the various drawers 104 to each other and/or one or more networks or devices external to chassis 100. Midplane 108 may comprise any system, device, or apparatus configured to interconnect information handling resources of chassis 100 with each other. Accordingly, midplane 108 may include slots, pads, and/or other connectors configured to receive corresponding electrical connectors of information handling resources in order to electrically couple information handling systems disposed in drawers 104 and/or information handling resources to each other.

A chassis management controller (CMC) 112 may be communicatively coupled to midplane 108 and may comprise any system, device, or apparatus configured to facilitate management and/or control of components of chassis 100, information handling systems modularly coupled within, and/or one or more of its component information handling resources. CMC 112 may be configured to issue commands and/or other signals to manage and/or control information handling systems coupled to slots 106 and/or information handling resources of chassis 100. CMC 112 may comprise a microprocessor, microcontroller, DSP, ASIC, field programmable gate array (“FPGA”), EEPROM, or any combination thereof.

In addition or alternatively, CMC 112 may also provide a management console for user/administrator access to these functions. For example, CMC 112 may provide for communication with a user interface (e.g., user interface 116), permitting a user to interact with CMC 112 and configure control and management of components of chassis 100 by CMC 112. As another example, CMC 112 may implement Web Services Management (“WS-MAN”) or another suitable management protocol permitting a user to remotely access a CMC 112 to configure chassis 100 and its various information handling resources. In such embodiments, a CMC 112 may interface with a network interface separate from a traditional network interface of chassis 100, thus allowing for “out-of-band” control of chassis 100, such that communications to and from CMC 112 are communicated via a management channel physically isolated from an “in band” communication channel with the traditional network interface. Thus, for example, if a failure occurs in chassis 100 that prevents an administrator from interfacing with chassis 100 via a traditional network interface and/or user interface 116 (e.g., operating system failure, power failure, etc.), the administrator may still be able to monitor and/or manage chassis 100 (e.g., to diagnose problems that may have caused failure) via CMC 112. In the same or alternative embodiments, CMC 112 may allow an administrator to remotely manage one or more parameters associated with operation of chassis 100 and its various information handling resources (e.g., power usage, processor allocation, memory allocation, security privileges, etc.).

One or more air movers 110 may be communicatively coupled to CMC 112, and may include any mechanical or electro-mechanical system, apparatus, or device operable to move air and/or other gasses. In some embodiments, an air mover 110 may comprise a fan (e.g., a rotating arrangement of vanes or blades which act on the air). In other embodiments, an air mover 110 may comprise a blower (e.g., a centrifugal fan that employs rotating impellers to accelerate air received at its intake and change the direction of the airflow). In these and other embodiments, rotating and other moving components of an air mover 110 may be driven by a motor. The rotational speed of such motor may be controlled by one or more control signals communicated from CMC 112. In operation, an air mover 110 may cool information handling systems and information handling resources of chassis 100 by drawing cool air into chassis 100 from outside chassis 100, expel warm air from inside chassis 100 to the outside of chassis 100, and/or move air across one or more heatsinks (not explicitly shown) internal to chassis 100 to cool one or more information handling systems and/or information handling resources. Although FIG. 1 depicts chassis 100 as having two air movers 110, chassis 100 may include any suitable number of air movers 110.

As shown in FIG. 1, chassis 100 may include one or more power supplies 114. Generally speaking, a power supply 114 may include any system, device, or apparatus configured to supply electrical current to one or more information handling resources within chassis 100.

A user interface 116 may include any system, apparatus, or device via which a user may interact with chassis 100 and its various components by facilitating input from a user allowing the user to manipulate chassis 100 and output to a user allowing chassis 100 to indicate effects of the user's manipulation. For example, user interface 116 may include a display suitable for creating graphic images and/or alphanumeric characters recognizable to a user, and may include, for example, a liquid crystal display, a cathode ray tube, a plasma screen, and/or a digital light processor projection monitor. In certain embodiments, such a display may be an integral part of chassis 100 and receive power from one or more power supplies 114 of chassis 100, rather than being coupled to chassis 100 via a cable. In some embodiments, such display may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor. In these and other embodiments, user interface 116 may include other user interface elements (e.g., a keypad, buttons, and/or switches placed in proximity to a display) allowing a user to provide input to chassis 100. In these and other embodiments, user interface 116 may include one or more visual indicators, such as light-emitting diodes, for example, for communicating information to a user. User interface 116 may be coupled to CMC 112 and/or other components of chassis 100, and thus may allow a user to configure various information handling systems and/or information handling resources of chassis 100.

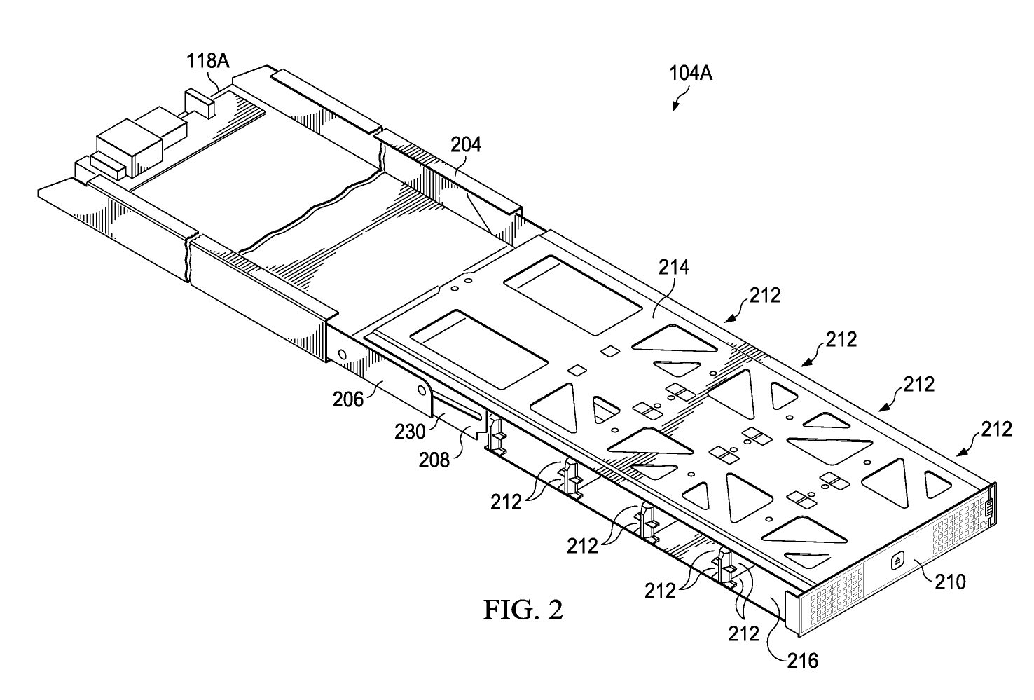

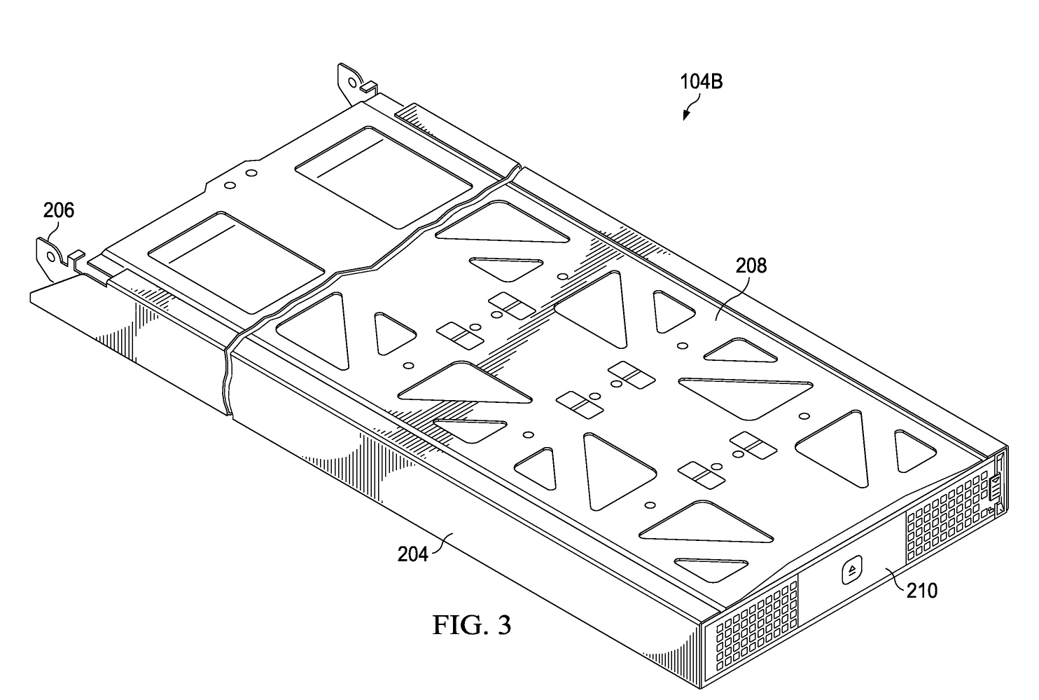

FIGS. 2 and 3 depict various views of an example chassis drawer 104A for carrying modular information handling resources, in accordance with embodiments of the present disclosure. FIG. 2 illustrates a perspective view of an example chassis drawer 104A for carrying modular information handling resources, wherein drawer 104A is in an open position drawn from chassis 100, in accordance with embodiments of the present disclosure. FIG. 3 illustrates a perspective view of chassis drawer 104A for carrying modular information handling resources, wherein drawer 104A is in a closed position relative to chassis 100, in accordance with embodiments of the present disclosure.

As shown in FIGS. 2 and 3, chassis drawer 104A may comprise an inner member 204, an intermediate member 206 mechanically coupled to inner member 204, and a carrier member 208 mechanically coupled to intermediate member 206. Inner member 204 may be constructed from steel, aluminum, plastic, and/or any other suitable material. Although inner member 204 may have any suitable size and/or shape, inner member 204 is depicted in the embodiments of FIGS. 2 and 3 as having two substantially planar and parallel opposite sides defining a drawer height coupled to each other by a substantially planar bottom generally perpendicular to the sides defining a drawer width and a guide flange extending from and running perpendicular to and along the length of each side such that the flanges project towards each other. In some embodiments, inner member 204 may be mechanically coupled to the internal mechanical structure of chassis 100, such that inner member 204 is fixed relative to chassis 100.

Intermediate member 206 may be constructed from steel, aluminum, plastic, and/or any other suitable material. Although intermediate member 206 may have any suitable size and/or shape, intermediate member 206 is depicted in the embodiments of FIGS. 2 and 3 as having two generally parallel and planar opposite sides coupled to each other by a substantially planar bottom generally perpendicular to the sides. The height of the sides and the width of the bottom may be such that the corresponding sides and bottom of inner member 204 provide a mechanical guide for intermediate member 206 as chassis drawer 104A is opened and closed. Intermediate member 206 may be mechanically coupled to inner member 204 via bearings and/or other mechanical components such that intermediate member 206 may slide relative to inner member 204 in a direction perpendicular to the drawer height and drawer width defined by inner member 204. In some embodiments, intermediate member 206 may be limited in the distance it may be drawn from chassis 100 through any combination of suitable structural elements. Similarly, in some embodiments, other mechanical components may restrict motion of intermediate member 206 relative to inner member 204 as chassis drawer 104A is translated from the open position to the closed position.

Carrier member 208 may be constructed from steel, aluminum, plastic, and/or any other suitable material. Although carrier member 208 may have any suitable size and/or shape, carrier member 208 is depicted in the embodiments of FIGS. 2 and 3 as having a substantially planar top 214 and a substantially planar bottom 216 generally parallel to each other defining a width and depth of carrier member 208, the top 214 and bottom 216 mechanically coupled to each other by one or more structural elements defining a height of carrier member 208, such that top 214 and bottom 216 are generally perpendicular to the sides of intermediate member 206. Carrier member 208 may also include a face 210 mechanically affixed to top 214 and/or bottom 216. As shown in FIGS. 2 and 3, top 214 may include one or more openings (e.g., above bays 212) allowing for gaseous fluid to pass through. Similarly, bottom 216 may also include one or more openings (e.g., below bays 212) allowing for gaseous fluid to pass through.

In some embodiments, face 210 may be substantially equal in width to the width of carrier member 208 and substantially equal to the height of carrier member 208. In these and other embodiments, face 210 may include handles, pull tabs, and/or other features allowing a person to pull on face 210 in order to translate chassis drawer 104A from a closed position to an open position in a direction generally parallel to the depth of top 214 and bottom 216. In these and other embodiments, face 210 may include a grill, vent, and/or other opening allowing gaseous fluid to enter and/or exit through face 210.

As shown in FIG. 2, each side of carrier member 208 (e.g., portions of carrier member 208 between the edges of and substantially parallel to top 214 and bottom 216) may include a web 230 configured to mechanically couple carrier member 208 to intermediate member 206, as well as openings for a plurality of bays 212.

Each of the various bays 212 defined by drawer 104A may include one or more electrical components for coupling an information handling resource (e.g., a hard disk drive) inserted into such bay 212 to other information handling resources of chassis 100. For example, a backplane (not explicitly shown) may couple a modular information handling resource disposed in a bay 212 to interface connector 118A, which, as described above, may in turn be coupled to midplane 108. In some embodiments, the various information handling resources may be coupled to interface connector 118A such that when chassis drawer 104A is drawn open relative to chassis 100, such information handling resources maintain electrical conductivity to interface connector 118A and interface connector 118A may maintain electrical conductivity to midplane 108, thus permitting insertion or removal of an information handling resource without affecting operation of other information handling resources carried by chassis drawer 104A. In such embodiments, interface connector 118A may only be decoupled from midplane 108 when the entirety of chassis drawer 104A is removed from chassis 100.

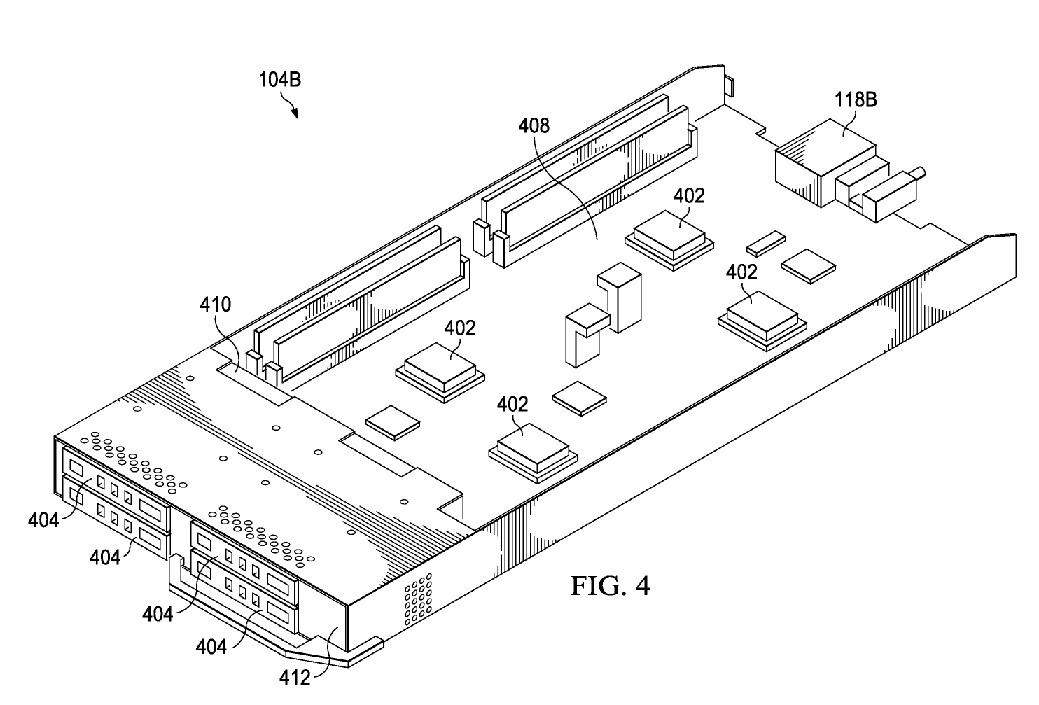

FIG. 4 illustrates a perspective view of another example chassis drawer 104B for carrying information handling resources, in accordance with embodiments of the present disclosure. Although not labeled in detail as in FIGS. 2 and 3, chassis drawer 104B may include one or more mechanical and/or structural elements (e.g., similar or identical to inner member 204, intermediate member 206, and carrier member 208) for translating chassis drawer 104B between open and closed positions relative to chassis 100. Similar to chassis drawer 104A, the various information handling resources carried by chassis drawer 104B may be coupled to interface connector 118B such that when chassis drawer 104B is drawn open relative to chassis 100, such information handling resources maintain electrical conductivity to interface connector 118B and interface connector 118B may maintain electrical conductivity to midplane 108, thus permitting insertion or removal of an information handling resource without affecting operation of other information handling resources carried by chassis drawer 104B. In such embodiments, interface connector 118B may only be decoupled from midplane 108 when the entirety of chassis drawer 104B is removed from chassis 100.

In the particular chassis drawer 104B depicted in FIG. 4, a backplane 408 may have thereon a plurality (e.g., four) of processors 402 and a chipset associated with each processor 402, thus defining four independent information handling systems carried by chassis drawer 104B. Interface connector 118B may also be coupled to backplane 408, thus coupling processors 402 to information handling resources of chassis 100 external to chassis drawer 104B.

In addition, the particular chassis drawer 104B depicted in FIG. 4 may include a plurality (e.g., four) of hard disk drives 404 communicatively coupled to backplane 408 (and thus one or more of processors 402) via a drive backplane 410.

As shown in FIG. 4, chassis drawer 104B may comprise a user interface 412. User interface 412 may include any system, apparatus, or device via which a user may interact with compute nodes (e.g., via a remote access controller such as an Integrated Dell Remote Access Controller or “iDRAC” for example) of chassis drawer 104B and its various components by facilitating input from a user allowing the user to compute nodes and to indicate effects of the user's manipulation. For example, user interface 412 may include a display suitable for creating graphic images and/or alphanumeric characters recognizable to a user, and may include, for example, a liquid crystal display, a cathode ray tube, a plasma screen, and/or a digital light processor projection monitor. In some embodiments, such display may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor. In these and other embodiments, user interface 412 may include other user interface elements (e.g., a keypad, buttons, and/or switches placed in proximity to a display) allowing a user to provide input to one or more compute nodes of chassis drawer 104B. In these and other embodiments, user interface 412 may include one or more visual indicators, such as light-emitting diodes, for example, for communicating information to a user.

Although FIGS. 2-4 depict particular example chassis drawers 104, chassis drawers 104 with other configurations may be employed consistent with the systems and methods herein disclosed. For example, in some embodiments, a chassis drawer 104 similar to that of chassis drawer 104B may include only one processor, such that the chassis drawer includes one compute node.

By combining different sizes and types of chassis drawers 104 in chassis 100, a user may create a multitude of different configurations of computing systems. For example, associations may be configured between information handling resources carried on a peripheral chassis drawer 104 to a compute node carried on a compute node chassis drawer 104. As used herein, a compute node chassis drawer 104 may comprise a chassis drawer 104 carrying one or more processors, such that one or more information handling systems, or compute nodes, are carried on the compute node chassis drawer. A peripheral chassis drawer 104 may comprise a chassis drawer 104 which does not carry a compute node, but carries one or more information handling resources (e.g., hard disk drives) for use by a compute node. Thus, a user may create one or more independent computing systems, each computing system comprising a compute node chassis drawer 104 and a peripheral chassis drawer 104.

However, in creating one or more systems comprising chassis drawers 104, a user may create a plurality of “disaggregated” computing systems in which an information handling system within one drawer 104 may be associated with information handling resources within one or more other drawers 104, and the association among various components within chassis 100 may not be readily apparent to the user.

Also, with shared-infrastructure systems such as those depicted herein, there may be an emphasis on maintaining low cost of the infrastructure. For example, to limit costs, user interface 116 of chassis 100 may lack a liquid crystal display or similar display device present in other multi-compute node chassis systems for facilitating selection of a compute node for input/output to keyboard-video-mouse (KVM) components coupled to chassis 100. In addition, cost and space constraints may also lead to an emphasis on reducing the number of other visual user interface elements, such as light-emitting diode (LED) indicators both on chassis 100 itself and chassis drawers 104 configured to be disposed therein.

Furthermore, to limit the physical size of chassis 100, certain external connectors (e.g., a connector for a KVM display device) may not be physically proximate to user interface elements (e.g., buttons for selecting a compute node of emphasis for KVM) associated with such external connectors, as is often the case in many traditional implementations of multi-compute node chassis systems. Accordingly, a user's appropriate interaction with user interface elements in order to select a compute node of emphasis for a display device coupled to an external connector may not be readily apparent.

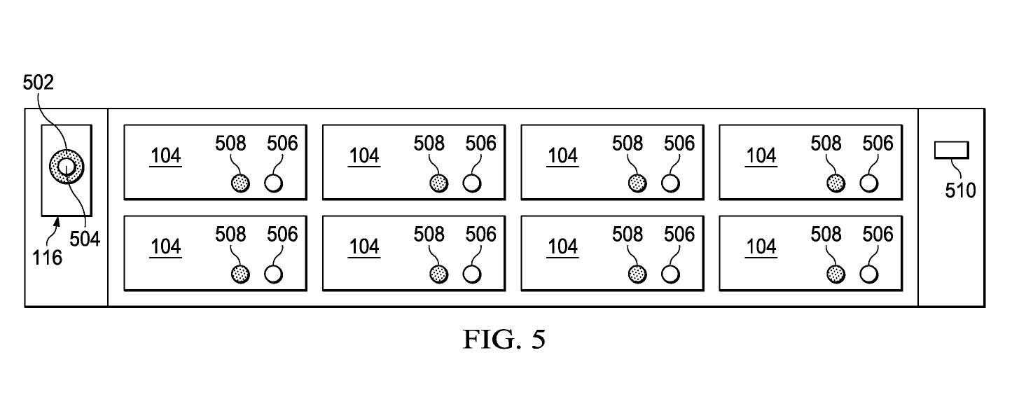

FIG. 5 illustrates a plan view of chassis 100 having chassis drawers 104 disposed therein, in accordance with embodiments of the present disclosure. As shown in FIG. 5, user interface 116 of chassis 100 may include an interface button 502. Interface button 502 may include any electromechanical device, system, or apparatus configured to actuate an electronic signal to be communicated to one or more other components of chassis 100 (e.g., CMC 112), in response to a user interaction with interface button 502 (e.g., interface button 502 being depressed by a user or otherwise manipulated). Responsive to user interaction with interface button 502, a compute node of emphasis for KVM, including a compute node of emphasis for a display coupled to connector 510, may be modified, such that the user may select a desired compute node for emphasis by interacting with interface button 502 until the desired compute node has emphasis.

In some embodiments, interface button 502 may include a visual indicator 504. Visual indicator 504 may include any device, system, or apparatus for providing a human-perceptible visual indication to a user of an event related to interface button 502, as described in greater detail below. In some embodiments, visual indicator 504 may comprise an LED. Although visual indicator 504 is shown as integral to interface button 502, in some embodiments visual indicator 504 may be separate from, but proximate to interface button 502.

Also as depicted in FIG. 5, chassis 100 may include a connector 510. Connector 510 may include any device, system, or apparatus configured to communicatively couple a peripheral device external to chassis 100 (e.g., a display monitor) to components internal to chassis 100. For example, in some embodiments, connector 510 may comprise a Video Graphics Array (VGA) connector.

One or more of the various chassis drawers 104 configured for use with chassis 100 may each include a visual indicator 506 and an interface button 508. Visual indicator 506 may include any device, system, or apparatus for providing a human-perceptible visual indication to a user of an event related to its associated chassis drawer 104, as described in greater detail below.

Interface button 508 may include any electromechanical device, system, or apparatus configured to actuate an electronic signal to be communicated to one or more other components of chassis 100 (e.g., CMC 112 via an associated chassis drawer 104 of the interface button 508 and backplane 108), in response to a user interaction with interface button 508 (e.g., interface button 508 being depressed by a user or otherwise manipulated). Responsive to user interaction with interface button 508, components of the chassis drawer 104 associated with the interface button and/or chassis 100 may work in concert to identify (e.g., by illuminating visual indicators 506 of appropriate chassis drawers 104) all chassis drawers 104 associated with (e.g., making up the same computing system as) the chassis drawer 104 with whose interface button 508 a user interacted.

To further illustrate, components of chassis 100 and one or more chassis drawers 104 disposed therein may be configured such that, when a user interacts with an interface button 508 on one chassis drawer 104, visual indicators 506 of each chassis drawer 104 within a computing system comprising the chassis drawer 104 with the particular interface button 508 with which the user interacted, may display an indication (e.g., illuminate) that all such chassis drawers 104 are within the same computing system, thus identifying components of chassis 100 which are within a computing system. For example, if a user interacts with an interface button 508 of a compute node chassis drawer 104, visual indicators 506 of all peripheral chassis drawers 104 within the same computing system as the compute node chassis drawer 104 may display an indication that the various chassis drawers 104 are within the same computing system. As another example, if a user interacts with an interface button 508 of a peripheral chassis drawer 104, visual indicators 506 of the compute node chassis drawer 104 and other peripheral chassis drawers 104 within the same computing system may display an indication that the various chassis drawers 104 are within the same computing system.

In a compute node chassis drawer 104 comprising multiple compute nodes (e.g., compute node 104B of FIG. 4), such chassis drawer 104 may include multiple visual indicators 506 (e.g., one for each compute node) or may have a visual indicator 506 configured to display a different visual indication for each compute node (e.g., different color). Similarly, in a peripheral chassis drawer 104 comprising individual peripherals which are independently assignable to different compute nodes, such chassis drawer 104 may include multiple visual indicators 506 (e.g., one for each compute node) or may have a visual indicator 506 configured to display a different visual indication for each compute node (e.g., different color). Thus, when identifying components of a computing system in such multi-compute node or multi-peripheral chassis drawers 104 in response to a user interaction with an interface button 508, the indication or indicator associated with such component may be displayed. In such embodiments, each compute node and/or peripheral of such multi-compute node or multi-peripheral chassis drawers 104 may have a corresponding interface button 508.

In these and other embodiments, components of chassis 100 and one or more chassis drawers 104 disposed therein may be configured such that visual indicators 506 of compute node chassis drawers 104 may display an indication indicating that a particular chassis drawer 104 and/or indicating that a particular compute node within a chassis drawer 104 has KVM emphasis. Thus, when a user interacts with (e.g., depresses) interface button 502, KVM emphasis may change from one chassis drawer 104/compute node to another, and the visual indicator 506 associated with the chassis drawer 104/compute node to which emphasis has been switched may display an indication indicating that the chassis drawer 104/compute node has KVM emphasis.

In such embodiments, the indication for indicating KVM emphasis may be different than the indication for identifying a chassis drawer 104/compute node as a component of a computing system. For example, in embodiments in which visual indicators 506 are LEDs, a visual indicator 506 may display one color for indicating KVM emphasis and display another color for indicating identity as a component of a computing system. In addition or alternatively, in embodiments in which visual indicators 506 are LEDs, a visual indicator 506 may blink at one frequency for indicating KVM emphasis and blink at another frequency for indicating identity as a component of a computing system. In addition or alternatively, a visual indicator 506 may display the indication for indicating KVM emphasis for a period of time immediately following the chassis drawer 104/compute node associated with the visual indicator 506 being selected for KVM emphasis, after which the visual indicator may then display the indicator for indicating identity as a component of a computing system, if applicable. Accordingly, a single visual indicator 506 on each chassis drawer 104 may be leveraged for indicating both computing system identity and KVM emphasis, thus potentially reducing cost and/or size of chassis 100.

In these and other embodiments, components of chassis 100 and one or more chassis drawers 104 disposed therein may be configured such that visual indicator 504 associated with interface button 502 may display an indication (e.g., illuminate, blink, or other suitable indication) responsive to a display device being coupled to connector 510. Accordingly, when a user couples a display device to connector 510, a visual indication is given of the interaction the user may perform (e.g., interacting with interface button) in order to select a desired compute node for KVM emphasis.

Although the present disclosure has been described in detail, it should be understood that various changes, substitutions, and alterations can be made hereto without departing from the spirit and the scope of the disclosure as defined by the appended claims.

What is claimed is:

1. A method comprising:
in a chassis comprising a plurality of slots each configured to receive a module and electrically and communicatively couple the module to other components of the chassis:
receiving an electrical signal indicative of a user interaction with an interface button integral to a first module received in one of the plurality of slots; and
responsive to the signal, causing display, from a respective visual indicator from each of one or more other modules which are a part of the same computing system as the first module, of a visual indication that the module having the visual indicator is part of the same computing system as the first module.

2. The method of claim 1, wherein the visual indicator is a light-emitting diode.

3. The method of claim 1, further comprising, responsive to keyboard-video-mouse emphasis being assigned to a particular module, causing display from the visual indicator of the particular module a second visual indication that the particular module is assigned keyboard-video-mouse emphasis.

4. The method of claim 3, wherein the visual indication is of one color and the second visual indication is of another color.

5. The method of claim 3, wherein the visual indication comprises blinking a light at one frequency and the second visual indication comprises blinking the light at another frequency.

6. A method comprising:
in a chassis comprising a plurality of slots each configured to receive a module and electrically and communicatively couple the module to other components of the chassis:
causing display, from a visual indicator integral to a module, of a first visual indication for identifying a computing system for which the module is a part; and
causing display from the visual indicator of the module of a second visual indication that the module is assigned keyboard-video-mouse emphasis responsive to the module receiving keyboard-video-mouse emphasis.

7. The method of claim 6, wherein the first visual indication is of one color and the second visual indication is of another color.

8. The method of claim 6, wherein the visual indication comprises blinking a light at one frequency and the second visual indication comprises blinking the light at another frequency.

9. The method of claim 6, wherein the visual indicator is a light-emitting diode.

10. A method comprising:
in a chassis comprising a plurality of slots each configured to receive a module and electrically and communicatively couple the module to other components of the chassis:
receiving a display device at a connector of the chassis; and
responsive to receiving the display device, causing display, from a visual indicator associated with an interface button for selecting keyboard-video-mouse emphasis for a selected module received in the chassis, of a visual indication that a user may select the selected module for emphasis via user interaction with the interface button.

11. The method of claim 10, wherein the visual indicator is a light-emitting diode.

12. The method of claim 10, wherein the visual indicator is integral to the interface button.
